(19) United States
(12) Patent Application Publication
(10) Pub. No.: US 2020/0310167 A1
(43) Pub. Date: Oct. 1, 2020

(54) DISPLAY DEVICE

(71) Applicant: SAKAI DISPLAY PRODUCTS CORPORATION, Sakai-shi, Osaka (JP)

(72) Inventor: Arimasa SUGIMOTO, Sakai-shi, Osaka (JP)

(73) Assignees: SAKAI DISPLAY PRODUCTS CORPORATION, Sakai-shi, Osaka (JP); SAKAI DISPLAY PRODUCTS CORPORATION, Sakai-shi, Osaka (JP)

(21) Appl. No.: 16/087,061

(22) PCT Filed: Mar. 23, 2016
(86) PCT No.: PCT/JP2016/059227

§ 371 Date: Dec. 27, 2018

(51) Int. Cl. G02F 1/01

(52) U.S. Cl. CPC G02F 1/0105

(57) ABSTRACT

The purpose of the present invention is to provide a display device capable of eliminating light leakage that deteriorates an image due to light leaking from a seam of a light blocking body surrounding ends of a display panel that displays images. A display device of the present invention is characterized by being provided with a display panel, a first frame, and a plurality of light blocking members (14) sandwiched between the first frame and the display panel, said light blocking members being continuously disposed in the peripheral direction of the display panel so that light is prevented from entering, at least in the predetermined direction, an image display region of the display panel.

### TECHNICAL FIELD

The present invention relates to display apparatuses.

### BACKGROUND ART

Conventional wisdom holds that the display quality of a liquid crystal display apparatus deteriorates if light enters the panel from a portion other than the light-receiving surface, which is called “light leakage.” To prevent such light leakage, the panel positioning frame of the display apparatus is configured to cover an end surface of the panel perpendicular to the light-receiving surface.

The positioning frame may be omitted in order to, for example, reduce the thickness of the display apparatus. Even in such a case, in order to prevent the light leakage, a light-blocking portion that covers the end surface of the panel may be employed. A display apparatus having such a feature has been described (Patent Document No. 1). Patent Document No. 1 also describes a configuration in which the light-blocking portion is provided between the front frame and the panel.

### CITATION LIST

### Patent Literature

Patent Document No. 1: Japanese Laid-Open Patent Publication No. 2013-171619

### SUMMARY OF INVENTION

### Technical Problem

Patent Document No. 1 describes the use of a light-blocking portion integrally formed as a single member. Such a light-blocking portion can be easily disposed between the front frame and panel of a display apparatus if the panel is of small to middle size. In a display apparatus having a large-size panel, a light-blocking portion needs to be divided into a plurality of pieces. In such a case, the light-blocking portion includes a plurality of members, and light may leak between each member.

In order to overcome the above problem, it is an object of the present invention to provide a technique of preventing light leakage that occurs in the case where a light-blocking portion including a plurality of members is disposed between the front frame and the panel.

### Solution to Problem

A display apparatus according to the present invention includes a display panel having a first surface including an image display region and a peripheral region surrounding the image display region, and a first frame fixed to the display panel, covering the peripheral region, and exposing the image display region. A plurality of light-blocking members are provided between the display panel and the first frame, and arranged continuously in a peripheral direction of the first surface so as to block or reduce entrance of light from an outside of the image display region through a space between the display panel and the first frame into the image display region at least in a direction normal to an edge of a first surface.

### Advantageous Effects of Invention

With the configuration of the present invention, light leakage can be prevented even in the case where a light-blocking portion including a plurality of members is provided between the front frame and the display panel.

### BRIEF DESCRIPTION OF DRAWINGS

FIG. 1 is a front perspective view showing main parts of a display apparatus according to an embodiment as viewed by a user from the front.

FIG. 2A is an exploded perspective view showing main parts of a display apparatus according to an embodiment.

FIG. 2B is a vertical cross-sectional view of a peripheral portion of the display apparatus of FIG. 2A.

FIG. 2C is a variation of the vertical cross-sectional view of the peripheral portion of the display apparatus of FIG. 2A.

FIG. 3A is a front view showing main parts of a display apparatus according to an embodiment as viewed by a user from the front.

FIG. 3B is a front view showing main parts of a display apparatus according to an embodiment as viewed by a user from the front.

FIG. 4A is an exploded perspective view showing main parts of a display apparatus according to an embodiment.

FIG. 4B is a vertical cross-sectional view of a peripheral portion of the display apparatus of FIG. 4A.

FIG. 4C is a variation of the vertical cross-sectional view of the peripheral portion of the display apparatus of FIG. 4A.

FIG. 5 is a front view showing variations of main parts of a display apparatus 10 according to an embodiment as viewed by a user from the front.

### DESCRIPTION OF EMBODIMENTS

A display apparatus according to the present invention will now be specifically described with reference to the accompanying drawings showing embodiments thereof. Note that in the descriptions of a second and a third embodiment, the same parts as those of a first embodiment will not be described.

### 1. First Embodiment

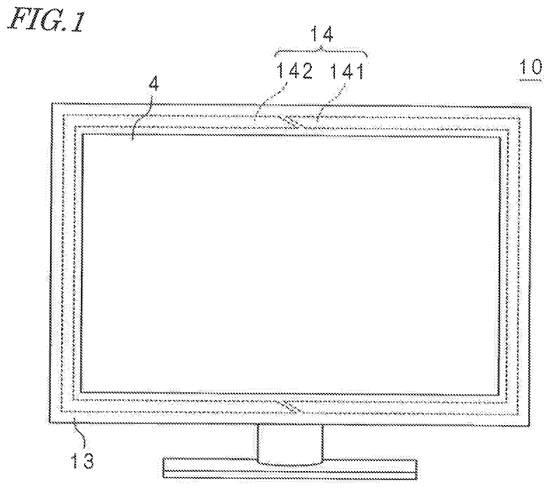

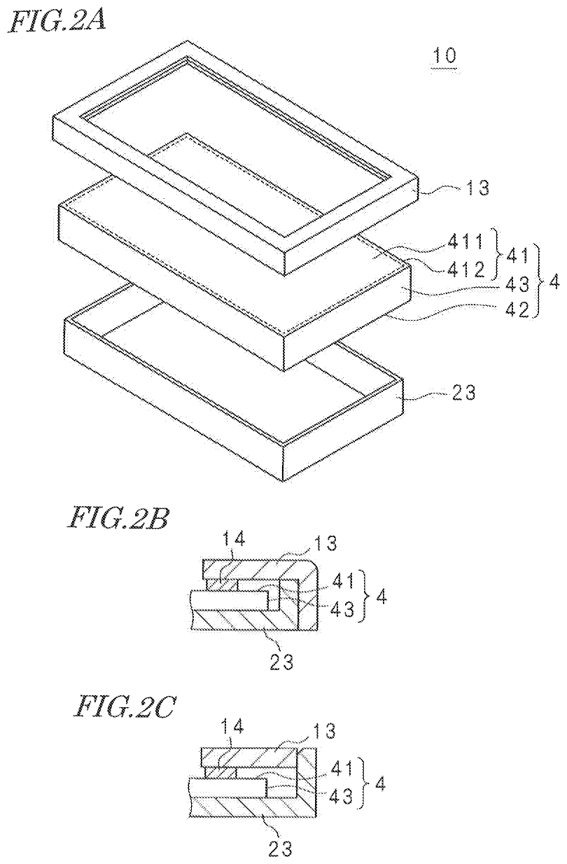

FIG. 1 is a front perspective view showing main parts of a display apparatus 10 according to the first embodiment as viewed by a user from the front. FIG. 2A is an exploded perspective view showing main parts of the display apparatus 10 of this embodiment. FIG. 2B is a vertical cross-sectional view of a peripheral portion of the display apparatus 10 of FIG. 2A. FIG. 2C is a variation of the vertical cross-sectional view of the peripheral portion of the display apparatus 10 of FIG. 2A.

The display apparatus 10 of this embodiment includes a display panel 4 and a front chassis 13 (first frame). The front chassis 13 of FIGS. 2A and 2B has an L-shaped cross-section.

The display panel 4 has a display surface 41 (first surface), a counter surface 42 (second surface), and an end surface 43 (third surface). The display surface 41, which presents an image (including video) to the user through an opening of the front chassis 13, includes an image display region 411, and a peripheral region 412 surrounding the image display region 411. The counter surface 42 is located behind the display surface 41 as viewed from the front by the user viewing the image. The end surface 43 links an edge of the display surface 41 to an edge of the counter surface 42. The peripheral region 412 of the display surface 41 is entirely covered by a peripheral portion of the opening of the front chassis 13, and the other region, i.e., the image display region 411, of the display surface 41 is exposed through the opening of the front chassis 13 toward the user.

In the display apparatus 10 of this embodiment, a light-blocking member 14 including a first light-blocking member 141 and a second light-blocking member 142 is supported in the peripheral region 412 of the display surface 41 of the display panel 4.

The front chassis 13 is fixed to the display panel 4, and the light-blocking member 14 is thereby sandwiched by the display panel 4 and the front chassis 13. Note that FIG. 2A shows the peripheral region 412, but not the light-blocking member 14.

The display panel 4 and the front chassis 13 may be fixed together by attaching the peripheral region 412 of the display surface 41 of the display panel 4 to the front chassis 13 with the light-blocking member 14 interposed therebetween, or alternatively, by fitting the display panel 4 into the front chassis 13 such that the end surface 43 of the display panel 4 is pressed against and thereby attached to an internal surface of the front chassis 13.

A distance (i.e., a length in a thickness direction) between a surface in contact with the front chassis 13 and a surface in contact with the display panel 4, of the light-blocking member 14, is preferably about 0.1 mm to 1.5 mm, more preferably about 0.3 mm to 1.0 mm. A distance (i.e., a length in a width direction) between a surface (also referred to as a “proximal surface”) closer to the image display region 411 and a surface (also referred to as a “distal surface”) farther from the image display region 411, of the light-blocking member 14, is preferably about 1.0 mm to 10 mm, more preferably 2.0 mm to 5.0 mm.

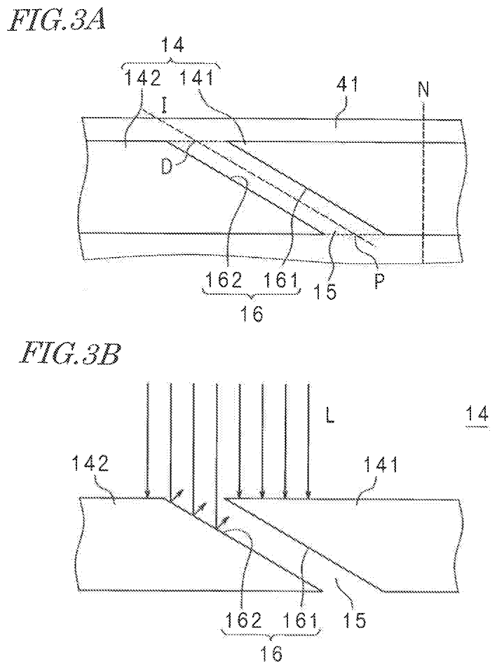

In the display apparatus 10 of this embodiment, the light-blocking member 14 includes a plurality of light-blocking members 14 (141, 142) that are arranged continuously in a peripheral direction of the display surface 41. In order to block or reduce the entrance of light from the outside of the image display region 411 through a space between the display panel 4 and the front chassis 13 into the image display region 411, it may be preferable that the first and second light-blocking members 141 and 142, which are adjacent to each other, should be closely joined to each other. However, when an error occurs during manufacture of the light-blocking member 14 or assembly of the display apparatus 10, a gap 15 (see FIG. 3A) may occur between the plurality of light-blocking members 14 (141, 142). In some cases, it is preferable that a gap 15 should be previously provided between the light-blocking members 14, taking it into account that the light-blocking members 14 may undergo thermal expansion.

In this embodiment, light that should be blocked is one that would otherwise enter the image display region 411 through a space between the display panel 4 and the front chassis 13. Such light comes from a side of the display panel 4, a large portion of which has traveled from the counter surface 42 and then come around to the end surface 43. A large portion of the light travels in the direction of a normal N (see FIG. 3A) to an edge of the display surface 41 (a boundary between the display surface 41 and the end surface 43) near the gap 15.

With this in mind, in the display apparatus 10 of this embodiment, the light-blocking members 14 (141, 142) that are arranged continuously in the peripheral direction of the display surface 41, are arranged so as to block or reduce the entrance of light from the outside of the image display region 411 through a space between the display panel 4 and the front chassis 13 into the image display region 411 at least in the direction of the normal N to the edge of the display surface 41, even when there is the gap 15 between the adjacent first and second light-blocking members 141 and 142. In the configuration shown in FIGS. 1, 2A, and 2B, the distal and proximal surfaces of the light-blocking member 14 are both parallel to the edge of the display surface 41, and perpendicular to the display surface 41. Therefore, the normal N shown in the figure is parallel to a normal to the distal surface of the light-blocking member 14 and a normal to the proximal surface of the light-blocking member 14.

In this embodiment, a shape of the gap 15 is defined by an opening (distal opening) D (see FIG. 3A) at the distal surface of the light-blocking member 14 and an opening (proximal opening) P (see FIG. 3A) at the proximal surface of the light-blocking member 14, which occur because the adjacent first and second light-blocking members 141 and 142 are not closely joined together, end surfaces 16 (an end surface 161 of the first light-blocking member and an end surface 162 of the second light-blocking member) (see FIG. 3A) facing each other of the light-blocking members, the display panel 4, and the front chassis 13.

In order to block or reduce the entrance of light from the outside of the image display region 411 through a space between the display panel 4 and the front chassis 13 into the image display region 411 at least in the direction of the normal N to the edge of the display surface 41, the gap 15 of the display apparatus 10 of this embodiment is configured such that light traveling at least in a predetermined direction (the direction of the normal N to the edge of the display surface 41) fails to enter from the outside to the inside of the image display region 411.

FIGS. 3A and 3B are front views showing main parts of the display apparatus 10 of this embodiment as viewed by the user from the front. FIG. 3A is an enlarged view showing a region including the end surface 161 of the first light-blocking member and the end surface 162 of the second light-blocking member. In FIG. 3A, the image display region 411 is located in the lower region. In FIG. 3A, the normal N is perpendicular to the edge of the display surface 41 near the gap 15.

As shown in detail in FIG. 3A, the angle between a straight line I connecting the distal opening D and the proximal opening P, and the edge of the display surface 41, is less than 90°. In addition, an image of the distal opening D that is projected on the proximal surface of the light-blocking member 14 in the direction of the normal N, does not overlap the proximal opening P. In other words, in the display apparatus 10 of this embodiment, the first light-blocking member 141 and the second light-blocking member 142 overlap each other in the direction of the normal N across the thickness direction.

As shown in FIG. 3B, such a configuration blocks or reduces passing of light L traveling in the direction of the normal N through the light-blocking member 14 from the outside to the inside of the image display region 411 (downward in FIG. 3B). FIG. 3B is a diagram for describing behavior of the light L entering the gap 15 in the direction of the normal N, showing the same region as that which is shown in FIG. 3A. Note that the display surface 41 is not shown in FIG. 3B. As a result, for the user, the distal opening D is unseen from the image display region 411 at least in the direction of the normal N. Specifically, even when the light L traveling from the outside of the image display region 411 toward the light-blocking member 14 passes through the distal opening D of the gap 15 without striking the distal surface of the first light-blocking member 141 or the second light-blocking member 142, that light L unavoidably strikes the end surface 162 of the second light-blocking member. The light striking the end surface 162 of the second light-blocking member is absorbed, or is reflected and then strikes the end surface 161 of the first light-blocking member. Thus, the light L that has passed through the distal opening D is absorbed by the end surface 161 of the first light-blocking member and the end surface 162 of the second light-blocking member, and is thereby attenuated such that the light does not reach the image display region 411.

To effectively achieve such an effect, the light-blocking member 14 is preferably capable of absorbing light, and is more preferably formed of a nonreflective material. In addition, the light-blocking member 14 is preferably formed of an optically non-transmissive material that does not transmit light entering the distal surface of the light-blocking member 14. Because the light-blocking member 14 is sandwiched by the display panel 4 and the front chassis 13, the light-blocking member 14 is preferably formed of an elastic material. Examples of the material for the light-blocking member 14 include a resin or a rubber.

In addition, the efficiency of the light attenuation increases with an increase in the number of times light that has passed through the distal opening D of the gap 15 strikes the surfaces of the light-blocking members 14 (the end surface 161 of the first light-blocking member or the end surface 162 of the second light-blocking member). Therefore, the angle between the straight line I and the normal N in FIG. 3A is preferably large.

As long as such a structure is provided, the distance between the end surfaces 161 and 162 of the adjacent first and second light-blocking members is not limited. Such a distance is preferably about the length in the thickness direction of the light-blocking member 14 and is preferably shorter than the length in the width direction of the light-blocking member 14, and is preferably about 0.1 mm to 5.0 mm, more preferably about 0.1 mm to 2.0 mm, and even more preferably about 0.1 mm to 1.0 mm.

Note that in FIGS. 3A and 3B, it is assumed that the end surface 161 of the first light-blocking member and the end surface 162 of the second light-blocking member, which face each other with the gap 15 interposed therebetween, are parallel to each other (the end surface 161 of the first light-blocking member and the end surface 162 of the second light-blocking member have complementary shapes). However, it is not essential that these surfaces are parallel to each other. As long as the light-blocking members 14 are arranged continuously in the peripheral direction of the display surface 41 so as to block or reduce the entrance of light from the outside of the image display region 411 through a space between the display panel 4 and the front chassis 13 into the image display region 411 at least in the direction of the normal N to the edge of the display surface 41, the display apparatus 10 can achieve the desired effect.

In the display apparatus 10 of this embodiment, the front chassis 13 is a frame-shaped metal member and has any suitable configuration known in the art, and preferably has a light weight and is preferably formed of, for example, an aluminum alloy. The display panel 4 may be either an organic electroluminescent (EL) panel or a liquid crystal panel, and has any suitable configuration known in the art.

As shown in FIGS. 2A-2C, the display apparatus 10 of this embodiment may include a back chassis 23 (third frame) that is a member of a housing that houses the display panel 4. In the display apparatus 10, the back chassis 23 has a shape and size similar to those of the front chassis 13, and has any suitable configuration known in the art.

As shown in FIGS. 2B and 2C, in the housing, the end surface 43 of the display panel 4 is covered by the front chassis 13 or the back chassis 23. As a result, the entrance of light from the outside of the housing through a space between the display panel 4 and the front chassis 13 into the image display region 411 can be blocked or reduced.

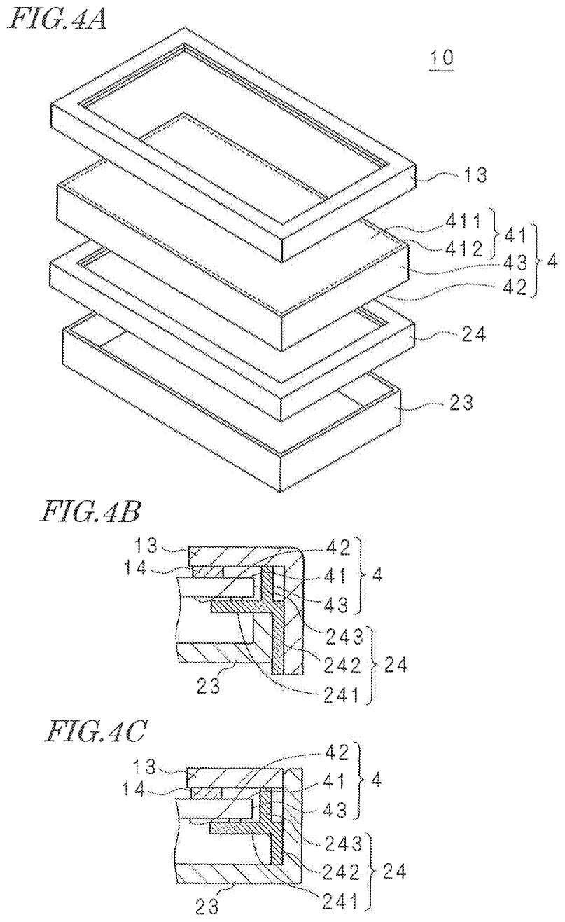

The housing of the display apparatus 10 of this embodiment is not particularly limited, as long as the light-blocking member 14 is sandwiched by the front chassis 13 and the peripheral region 412 of the display surface 41 of the display panel 4. As shown in FIG. 2B and FIG. 4B described below, the back chassis 23 may be fitted into the inside of the front chassis 13. Alternatively, as shown in FIG. 2C and FIG. 4C described below, the front chassis 13 may be fitted into the inside of the back chassis 23.

In the illustrated example, the image display region 411 is rectangular, and the display panel 4 is in the shape of a rectangular parallelepiped with the display surface 41 orthogonal to the end surface 43. The shape of the display panel 4 is not limited to this. For example, the image display region 411 of the display surface 41 may be circular, or the counter surface 42 of the display panel 4 may be larger than the display surface 41 (e.g., a frustum).

In the example illustrated in FIG. 2, like an organic EL display, a backlight mechanism is not provided. Alternatively, the display apparatus 10 of this embodiment may be further provided with a backlight mechanism. In that case, as shown in FIGS. 4A-4C, the display apparatus 10 of this embodiment preferably further includes a panel chassis 24 (second frame). A backlight mechanism (not shown) is provided in a region between the panel chassis 24 and the back chassis 23.

FIG. 4A is an exploded perspective view showing main parts of the display apparatus 10 of this embodiment. FIG. 4B is a vertical cross-sectional view of a peripheral portion of the display apparatus 10 of FIG. 4A. FIG. 4C is a variation of the vertical cross-sectional view of the peripheral portion of the display apparatus 10 of FIG. 4A. The panel chassis 24 is fixed by a joint portion 242 being joined to the front chassis 13 and the back chassis 23. This can assist in positioning the display panel 4 supported by a mount portion 241.

In addition, as shown in FIGS. 4B and 4C, in the housing, at least one of the front chassis 13, the back chassis 23, and the panel chassis 24 covers the end surface 43 of the display panel 4. This can block or reduce the entrance of light from the outside of the housing through a space between the display panel 4 and the front chassis 13 into the image display region 411.

In addition, the panel chassis 24 supports a region of the counter surface 42 facing the peripheral region 412 of the display surface 41, of the display panel 4 so that the display panel 4 is sandwiched between the panel chassis 24 and the front chassis 13. Because the panel chassis 24 supports the above region, the direct entrance of a light from the backlight mechanism for generating light that illuminates the counter surface 42 of the display panel 4 into the above region can be blocked or reduced. In particular, if, as shown in FIGS. 4B and 4C, the panel chassis 24 includes a counter portion 243 facing the end surface 43, the counter portion 243 covers the end surface 43 and can thereby block or reduce the entrance of light from the backlight mechanism through the housing and then coming around to the end surface 43, and then through a space between the display panel 4 and the front chassis 13, into the image display region 411.

A spacer serving as a buffer material may be provided between the panel chassis 24 and the display panel 4 or the backlight mechanism. Such a spacer may be, but not limited to, an elastic material (e.g., a resin or a rubber).

In the display apparatus 10 of this embodiment, a backlight mechanism known in the art may be employed. The backlight mechanism may be either a direct-lit backlight or an edge-lit backlight. A light source is preferably an LED, which is not limited to a white LED, and may be a blue LED combined with a fluorescent material-containing film (e.g., a quantum dot film). The light source is not limited to the above LEDs, and may, for example, be various fluorescent lamps or organic EL panels.

The panel chassis 24 may be a member formed of a resin, and may have any suitable configuration known in the art. In the case where the panel chassis 24 is black, an edge region of an image on the display surface 41 appears dark. Therefore, the panel chassis 24 may be formed of a white or near-white resin.

In the display apparatus 10 of this embodiment, the panel chassis 24 is preferably formed of a white or near-white resin. Such a configuration allows the display apparatus 10 of this embodiment to display a bright image even in the edge region of the display surface 41. As used herein, the term “white or near-white” basically refers to white. However, for example, “white” products produced by different material manufacturers may have slightly different shades of white. The term “white or near-white” as used herein encompasses a wide range of shades of white.

The white or near-white resin may be, but not limited to, a white or near-white polycarbonate resin. In the display apparatus 10 of this embodiment, a white or near-white polycarbonate resin containing a small amount of carbon black is preferably used. Instead of the polycarbonate resin, a mixture of a polycarbonate and a glass, an ABS resin, a mixture of an ABS resin and a polycarbonate resin, etc., may be used as the white or near-white resin.

Note that in the case where the panel chassis 24 is formed of a white or near-white resin, such a resin is optically transmissive, and therefore, it is significantly difficult to block or reduce the entrance of light from the backlight mechanism through the housing and then coming around to the end surface 43 into the image display region 411. However, in the display apparatus 10 of this embodiment, the light-blocking member 14 is sandwiched between the display panel 4 and the front chassis 13, and therefore, the above drawback can be avoided and thereby the desired effect can be achieved.

### 2. Second Embodiment

As described in the first embodiment, a large portion of light that would enter the image display region 411 through a space between the display panel 4 and the front chassis 13 travels in the direction of the normal N to the edge of the display surface 4 (the boundary between the display surface 41 and the end surface 43). The light that would enter the image display region 411 also contains light traveling in directions other than the direction of the normal N. Therefore, in this embodiment, such light is also preferably blocked.

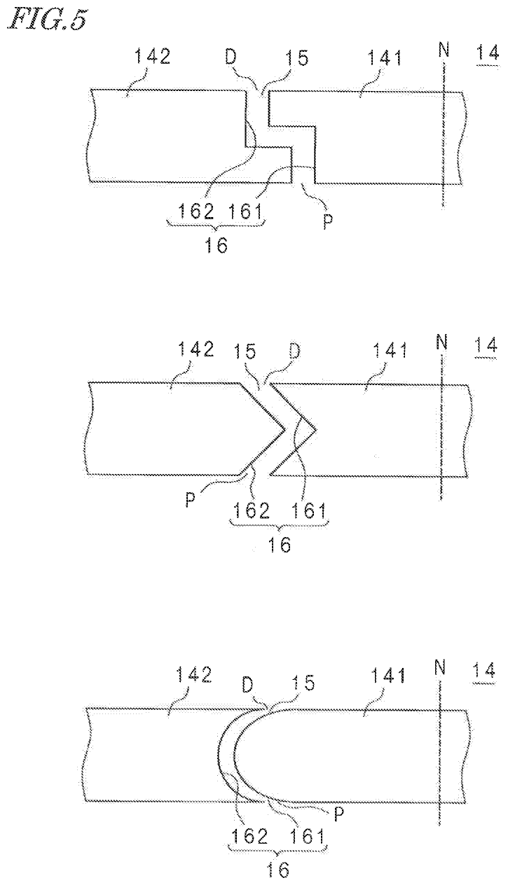

FIG. 5 is a front view showing variations of main parts of the display apparatus 10 of this embodiment as viewed by a user from the front. As with FIG. 3A, FIG. 5 is an enlarged view showing a region including the end surface 161 of the first light-blocking member and the end surface 162 of the second light-blocking member.

In the display apparatus 10 of this embodiment, the light-blocking members 14 are arranged continuously in the peripheral direction of the display surface 41 so as to block or reduce the entrance of light from the outside of the image display region 411 through a space between the display panel 4 and the front chassis 13 into the image display region 411 in any direction. Therefore, light traveling in the direction of the straight line I of FIG. 3 (i.e., light entering the gap 15 through the distal opening D and directly exiting the gap 15 through the proximal opening P) can also be blocked or reduced.

In order to block or reduce the entrance of light from the outside of the image display region 411 through a space between the display panel 4 and the front chassis 13 into the image display region 411 in any direction, the display apparatus 10 of this embodiment is configured such that any line segment connecting the distal opening D and the proximal opening P of the light-blocking member 14 is interrupted by at least one of the end surface 161 of the first light-blocking member and the end surface 162 of the second light-blocking member.

The gap 15 of the display apparatus 10 of this embodiment is formed such that a frustum having the distal opening D of the light-blocking member 14 as the upper surface, the proximal opening P as the lower surface, and a surface connecting the edges of the distal and proximal openings D and P as the side surface, is occupied to some extent by at least one of the first light-blocking member 141 and the second light-blocking member 142, so that even when the light L traveling from the outside of the image display region 411 toward the light-blocking member 14, has passed through the distal opening D of the gap 15 without striking the distal surface of the first light-blocking member 141 or the second light-blocking member 142, that light L unavoidably strikes at least one of the end surface 161 of the first light-blocking member and the end surface 162 of the second light-blocking member. As a result, the light striking the end surface 161 of the first light-blocking member or the end surface 162 of the second light-blocking member is absorbed, or is reflected and then strikes the end surface 162 of the second light-blocking member or the end surface 161 of the first light-blocking member, respectively. Thus, the light L that has passed through the distal opening D is absorbed by the end surface 161 of the first light-blocking member and the end surface 162 of the second light-blocking member, and is thereby attenuated such that the light does not reach the image display region 411.

As shown in FIG. 5, such a configuration blocks or reduce the entrance of light from the outside to the inside of the image display region 411 (downward in FIG. 5) through the light-blocking member 14 in any direction that is not limited to the direction of the normal N. As a result, for the user, the distal opening D is unseen from the image display region 411 in any direction.

To effectively achieve such an effect, among the features described in the first embodiment, the light-blocking member 14 is preferably capable of absorbing light, and is more preferably formed of a nonreflective material. In addition, in order to increase the efficiency of the light attenuation, the shape of the above frustum is designed so that the total number of times light that has passed through the distal opening D of the gap 15 strikes the surfaces of the light-blocking members 14 (the end surface 161 of the first light-blocking member or the end surface 162 of the second light-blocking member) is increased. Examples of such a shape are shown in FIG. 5. The shape is not limited to these examples. It is apparent to those skilled in the art that the configuration of the second embodiment may be modified or varied.

### 3. Third Embodiment

As described above, in order to block or reduce the entrance of light from the outside of the image display region 411 through a space between the display panel 4 and the front chassis 13 into the image display region 411, it is preferable that the adjacent first and second light-blocking members 141 and 142 should be closely joined together. Nevertheless, even if the adjacent first and second light-blocking members 141 and 142 are not closely joined together, then when at least one portion is provided that is closed by the end surface 161 of the first light-blocking member and the end surface 162 of the second light-blocking member, the entrance of light from the outside of the image display region 411 through a space between the display panel 4 and the front chassis 13 into the image display region 411 in any direction including the normal N to the edge of the display surface 41, can be blocked or reduced.

In other words, in order to block or reduce the entrance of light from the outside of the image display region 411 through a space between the display panel 4 and the front chassis 13 into the image display region 411 in any direction including the normal N to the edge of the display surface 41 after passing, at least one portion closed by the end surface 161 of the first light-blocking member and the end surface 162 of the second light-blocking member is provided between the adjacent first and second light-blocking members 141 and 142. The “closed portion” is formed by a line segment on the end surface 161 of the first light-blocking member that connects a certain point of an edge thereof closer to the front chassis 13 and a certain point of an edge thereof closer to the display panel 4 being entirely in contact with the end surface 162 of the second light-blocking member. In other words, the end surface 161 of the first light-blocking member and the end surface 162 of the second light-blocking member are in contact with each other throughout the entire line segment. At least one such line segment is provided. The number of such line segments is not particularly limited.

With such a configuration, in the display apparatus 10 of this embodiment, even in the case where the distal opening D and the proximal opening P are present, the region from the distal opening D to the proximal opening P has at least one closed portion, and therefore, the entrance of light from the outside of the image display region 411 through a space between the display panel 4 and the front chassis 13 into the image display region 411 can be blocked or reduced. As a result, light leakage between the display panel 4 and the front chassis 13 cannot be noticed by the user from the image display region 411 in any direction.

If a line segment that is the distal edge of the end surface 161 of the first light-blocking member is entirely in contact with the end surface 162 of the second light-blocking member, the distal opening D is not present. If a line segment that is the proximal edge of the end surface 161 of the first light-blocking member is entirely in contact with the end surface 162 of the second light-blocking member, the proximal opening P is not present. Thus, if the distal opening D and/or the proximal opening P is present, it can also be said that the region from the distal opening D to the proximal opening P has at least one closed portion, and therefore, light from the outside of the image display region 411 through a space between the display panel 4 and the front chassis 13 into the image display region 411 can be blocked or reduced.

As described above, by employing the configurations of the first to third embodiments, light leakage at a joint portion of a plurality of light-blocking members 14 can be prevented at least in a predetermined direction. As a result, a deterioration in display quality due to light leakage can be prevented. In particular, in the case where the display apparatus 10 includes a large-size panel (e.g., the display panel 4 whose longer side has a length exceeding one meter), it is difficult to employ an integrally-formed light-blocking member 14. According to this embodiment, the light-blocking member 14 can be formed of a plurality of separate parts, and therefore, the display apparatus 10 including a large-size panel can be provided without manufacturing constraints.

According to the first and second embodiments, the presence of the gap 15 between the light-blocking members 14 is allowable. Therefore, the influence of a dimension error of the light-blocking members 14, and the influence of an assembly error in fixation of the light-blocking members 14, can be significantly reduced, leading to simplification of manufacture of the display apparatus 10.

According to the first to third embodiments, the shapes of the light-blocking members 14 are not limited. Therefore, if as many members having the same shape as possible are used, the number of parts constituting the display apparatus 10 can be reduced.

Note that in the third embodiment, irrespective of the shape of the gap 15, the gap 15 has at least one portion closed by the end surface 161 of the first light-blocking member and the end surface 162 of the second light-blocking member. It is apparent that a combination of the first embodiment with the third embodiment, and a combination of the second embodiment with the third embodiment, are within the scope of the present invention.

The technical features (constituent elements) described in the examples may be combined together, and the resultant combinations may form new technical features. It should be understood that the embodiments herein are illustrative in all respects and not restrictive. The scope of the invention is defined by the appended claims, and therefore, all changes that fall within metes and bounds of the claims, or equivalence of such metes and bounds thereof, are intended to be embraced by the claims.

### REFERENCE SIGNS LIST

10 display apparatus
13 front chassis (first frame)
14 light-blocking member
141 first light-blocking member
142 second light-blocking member
15 gap
16 end surface of light-blocking member
161 end surface of first light-blocking member
162 end surface of second light-blocking member
23 back chassis (third frame)
24 panel chassis (second frame)
241 mount portion
242 joint portion
243 counter portion
4 display panel
41 display surface (first surface)
411 image display region
412 peripheral region
42 counter surface (second surface)
43 end surface (third surface)
D distal opening
L light
N normal
P proximal opening

1. A display apparatus comprising:
a display panel having a first surface and a second surface facing the first surface, the first surface including an image display region and a peripheral region surrounding the image display region;
a first frame fixed to the display panel, covering the peripheral region, and exposing the image display region;
a second frame formed of a white or near-white resin and for supporting a region of the second surface facing the peripheral region of the first surface so that the display panel is sandwiched between the first and second frames,
wherein a plurality of light-blocking members are provided between the display panel and the first frame, and arranged continuously in a peripheral direction of the first surface so as to block or reduce entrance of light from an outside of the image display region through a space between the display panel and the first frame into the image display region at least in a direction normal to an edge of a first surface.

2. The display apparatus of claim 1, wherein
a gap between a first light-blocking member and a second light-blocking member adjacent to each other of the plurality of light-blocking members, has an opening distal to the image display region and an opening proximal to the image display region, and any line segment connecting the distal and proximal openings is interrupted by at least one of an end surface of the first light-blocking member and an end surface of the second light-blocking member.

3. The display apparatus of claim 1, wherein
a gap between a first light-blocking member and a second light-blocking member adjacent to each other of the plurality of light-blocking members, has at least one portion closed by an end surface of the first light-blocking member and an end surface of the second light-blocking member.

4. (canceled)

5. The display apparatus of claim 1, further comprising:
a backlight mechanism for generating light that illuminates the second surface of the display panel.
